(19) United States
(12) Patent Application Publication
(10) Pub. No.: US 2023/0025133 A1
(43) Pub. Date: Jan. 26, 2023

(54) PORTABLE WORKSTATION

(71) Applicant: ADVANTUS, CORP., Jacksonville, FL (US)

(72) Inventors: David A. Schenker, Cedarburg, WI (US); Chris Pitzo, Pewaukee, WI (US)

(73) Assignee: ADVANTUS, CORP., Jacksonville, FL (US)

(21) Appl. No.: 17/381,513

(22) Filed: Jul. 21, 2021

(51) Int. Cl. E04B 2/74; A47B 97/00; A47G 5/00

(52) U.S. Cl. CPC E04B 2/7422; A47B 97/00; A47G 5/00; A47B 2200/12

(57) ABSTRACT

A portable workstation includes a base having a perimeter and a plurality of base fasteners positioned along the perimeter, a first sidewall with a side and a plurality of sidewall fasteners positioned along the side, and a second sidewall with a side and a plurality of sidewall fasteners positioned along the side. The first sidewall is coupled to the base by positioning the side of the first sidewall along the perimeter such that at least one sidewall fastener of the first sidewall couples to one of the base fasteners, and the second sidewall is coupled to the base by positioning the side of the second sidewall along the perimeter such that at least one sidewall fastener of the second sidewall couples to one of the base fasteners. The first sidewall and the second sidewall can be coupled to the base in different positions relative to the base to thereby change the configuration of the workstation.

### FIELD

The present disclosure relates to a portable workstation, and specifically a portable workstation with stackable and rearrangeable sidewalls.

### BACKGROUND

Users of mobile electronic devices, such as smart phones, tablets, and laptops, can work from any location. For instance, a user could work at a coffee shop, a shared workspace, or a public location. Many of these users desire privacy when working in public spaces, and thus, there is a need in the industry for workstations that are easy to transport and that shield or protect the user and the display of their mobile electronic device from public view.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a portable workstation includes a base having a perimeter and a plurality of base fasteners positioned along the perimeter, a first sidewall with a side and a plurality of sidewall fasteners positioned along the side, and a second sidewall with a side and a plurality of sidewall fasteners positioned along the side. The first sidewall is coupled to the base by positioning the side of the first sidewall along the perimeter such that at least one sidewall fastener of the first sidewall couples to one of the base fasteners, and the second sidewall is coupled to the base by positioning the side of the second sidewall along the perimeter such that at least one sidewall fastener of the second sidewall couples to one of the base fasteners. The first sidewall and the second sidewall can be coupled to the base in different positions relative to the base to thereby change the configuration of the workstation.

Various other features, objects, and advantages will be made apparent from the following description taken together with the drawings.

### BRIEF DESCRIPTION OF THE DRAWINGS

FIG. 1 is a perspective view of an example workstation of the present disclosure.

FIG. 2 is a plan view of a base, a first sidewall, and a second sidewall of an example workstation of the present disclosure. The base, the first sidewall, and the second sidewall are each in an unfolded position and disconnected from each other.

FIG. 3A-3C are perspective views that depict an example sequence for moving the base from the unfolded position to a folded position.

FIGS. 4A-4C are perspective views that depict an example sequence for moving the first sidewall from the unfolded position to a folded position.

FIG. 5 is a perspective view of the base, the first sidewall, and the second sidewall each in a folded position and stacked relative to each other.

FIG. 6 is a top-down plan view of the base and the sidewalls in unfolded positions.

FIG. 7 is a perspective view of the workstation in a first erected configuration.

FIG. 8 is a top-down plan view of the base and the sidewalls in the first erected configuration.

FIG. 9 is a top-down plan view of the base and the sidewalls in unfolded positions.

FIG. 10 is a perspective view of the workstation in a second erected configuration.

FIG. 11 is a top-down plan view of the base and the sidewalls in the second erected configuration.

FIG. 12 is a top-down plan view of the base and the sidewalls in unfolded positions.

FIG. 13 is a perspective view of the workstation in a third erected configuration.

FIG. 14 is a top-down plan view of the base and the sidewalls in the third erected configuration.

FIG. 15 is a top-down plan view of the base and the sidewalls in unfolded positions.

FIG. 16 is a perspective view of the workstation in a flat configuration.

FIG. 17 is a top-down plan view of the base and the sidewalls in the flat configuration.

### DETAILED DESCRIPTION

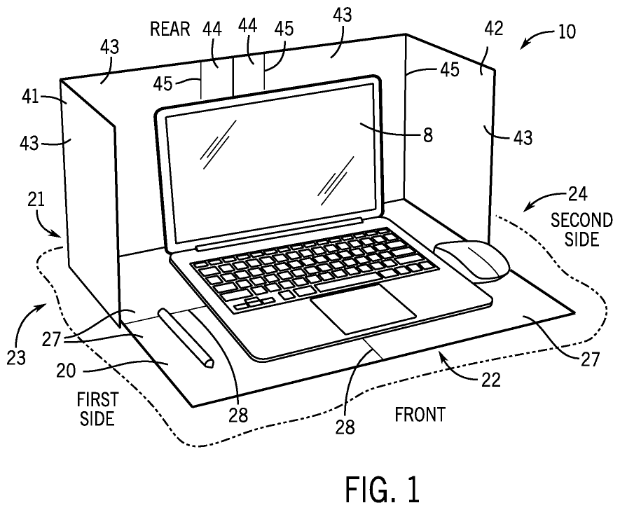

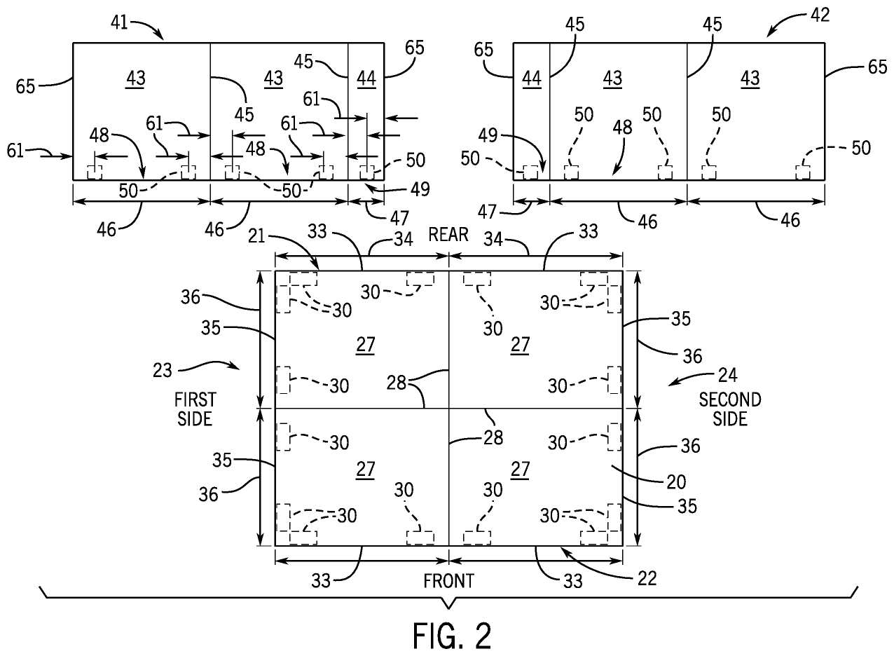

FIGS. 1-2 depict a workstation 10 of the present disclosure. In FIG. 1, the workstation 10 is in a first erected configuration, and a laptop 8 is positioned within the workstation 10. While in the first erected configuration, sidewalls 41, 42 of the workstation 10 extend along an end and the opposing sides of the base 20 to thereby shield the display of the laptop 8 and the user from third parties.

The base 20 and the sidewalls 41, 42 are depicted in greater detail in FIG. 2. Note that FIG. 2 is a top-down plan view of the base 20 and the sidewalls 41, 42.

The base 20 is rectangular and generally extends between a first end 21 (rear) and an opposite second end 22 (front) and further between a first side 23 and a opposite second side 24. The base 20 has a plurality of base panels 27. Each base panel 27 is connected to at least one other base panel 27. As such, the base panels 27 remain connected to each other as the base 20 is folded or unfolded (as described further herein). Seams 28 are defined between the base panels 27. Each base panel 27 has an end 33 with a first base length 34 and a side 35 with a second base length 36. Collectively, the ends 33 and the sides 35 of the base panels 27 form an exterior perimeter of the base 20.

The base panels 27 can be formed form any suitable material such as plastic or materials with paper fibers. In one specific example, each base panel 27 includes a center plate (e.g., cardboard or plastic) encased in upper and lower sheets of materials (e.g., plastic film, leather). In this example, the upper and lower sheets encase the center plate and the upper and lower sheets are welded or stitched together along the edges of the center plate and thus, the upper and lower sheets form the seams 28.

Base fasteners, such as magnets 30, are positioned along the ends 33 and the sides 35 of the base panels 27 such that the magnets 30 are positioned along the exterior perimeter of the base 20. The magnets 30 are preferably embedded into the base panels 27. Note that the magnets 30 are depicted with dashed lines as the size and the shape of the magnets 30 can vary. Also note that the position of the magnets 30 along the ends 33 and the sides 35 of the base panels 20 can also vary from the positions depicted. In the example depicted, four magnets 30 are positioned along each end 21, 22 and each side 23, 24 of the base 20. In other examples, the magnets 30 are mounted to an exterior surface of the base panels 27. In other examples, the base fasteners are hook-and-loop strips that connect to corresponding hook-and-loop strips on the sidewalls 41, 42.

Each sidewall 41, 42 has a pair of first sidewall panels 43 and a single second sidewall panel 44. The first sidewall panels 43 are similar to each other, and each sidewall panel 43, 44 is connected to one of the other sidewall panels 43, 44. As such, the sidewall panels 43, 44 remain connected to each other as the sidewall 41, 42 are folded or unfolded (as described further herein). Seams 45 are defined between the sidewall panels 43, 44. Each first sidewall panel 43 has a bottom side 48 with a first sidewall length 46 and the second sidewall panel 44 has a bottom side 49 with second sidewall length 47. The second sidewall length 47 is less than the first sidewall length 46. The bottoms sides 48, 49 of the sidewall panels 43, 44 collectively form an exterior bottom edge of each sidewall 41, 42.

Like the base panels 27, the sidewall panels 43, 44 can be formed form any suitable material such as plastic or materials with paper fibers. In one specific example, each sidewall panel 43, 44 includes a center plate (e.g., cardboard or plastic) encased in upper and lower sheets of materials (e.g., plastic film, leather). In this example, the upper and lower sheets encase the center plate and the upper and lower sheets are welded or stitched together along the at least one edge of the center plate to thereby form the seams 45.

Sidewall fasteners, such as magnets 50, are also positioned along the bottom side 48, 49 of the base panels 27. The magnets 50 are preferably embedded into the sidewall panels 43,44. Note that the magnets 50 are depicted with dashed lines as the size and the shape of the magnets 50 can vary. Also note that the position of the magnets 50 can also vary from the positions depicted. In other examples, the magnets 30 are mounted to an exterior surface of the base panels 27. In other examples, the sidewall fasteners are hook-and-loop strips.

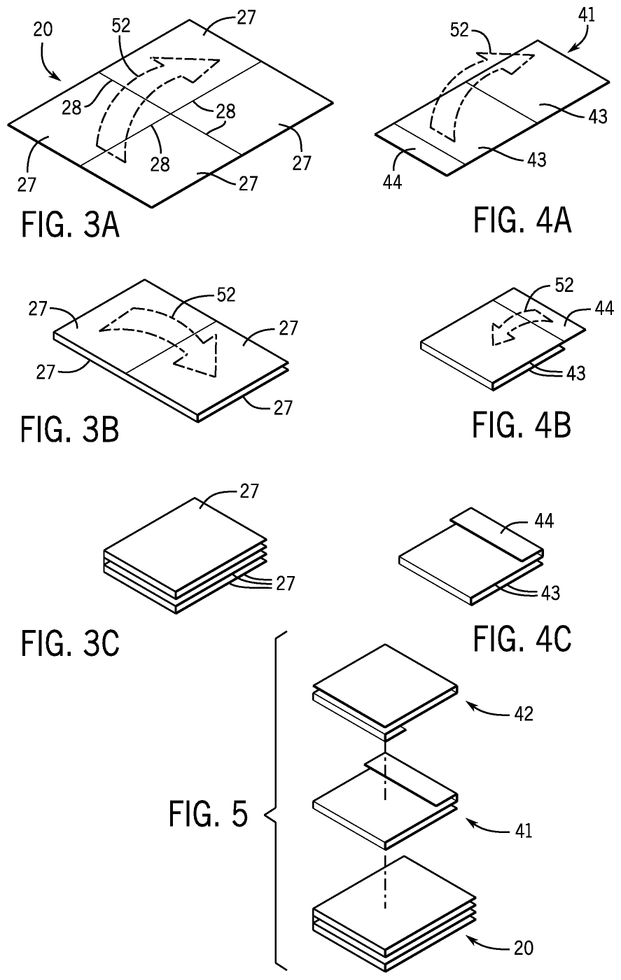

As noted above the base 20 and the sidewalls 41, 42 are each foldable into and between a folded position and an unfolded position. Example sequence for moving (e.g., folding) the base 20 and the sidewalls 41, 42 are depicted as dashed arrows 52. FIGS. 3A-3C depict folding the base 20 from the unfolded position (see FIGS. 2 and 3A) to the folded position (FIG. 3C). Note that the base panels 27 remain connected to each other via the seams 28 while being moved between the folded position, the unfolded position, and any intermediate positions. FIGS. 4A-4C, depict folding the first sidewall 41 from the unfolded position (see FIGS. 2 and 4A) to the folded position (FIG. 4C). Note that the second sidewall 42 is folded and unfolded in a similar manner, and note that the sidewall panels 43, 44 remain connected to each other via the seams 45 while being moved between the folded position, the unfolded position, and any intermediate positions. FIG. 5 depicts the sidewalls 41, 42 stacked upon the base 20.

In the example depicted in FIG. 2, the magnets 30, 50 are positioned relative to the seams 28, 45 and the edges of the panels 27, 43, 44. That is, the centerline of each magnet 50 of the sidewall 41, 42 is positioned a first distance 61 away from an adjacent seam 45 and/or adjacent end 65 of the sidewall 41, 42. Similarly, the centerline of each magnet 30 of the base 20 is positioned the same first distance 61 away from an adjacent seam 28, adjacent side 35, or adjacent end 33 of the base 20. Thus, the spacing of the magnets 30, 50 along the bottom sides 49 of the sidewalls 41, 42 and the perimeter of the base 20 is similar and accordingly, the magnets 50 of the sidewalls 41, 42 can be coupled to the magnets 30 in different positions such that the user can change the configuration of the workstation 10 (described further herein). In one specific example, centerline of each magnet 50 of the sidewall 41, 42 is positioned 2.55 inches from an adjacent seam 45 and/or adjacent end 65 of the sidewall 41, 42 and the centerline of each magnet 30 of the base 20 is positioned the 2.55 inches away from an adjacent seam 28, adjacent side 35, or adjacent end 33 of the base 20.

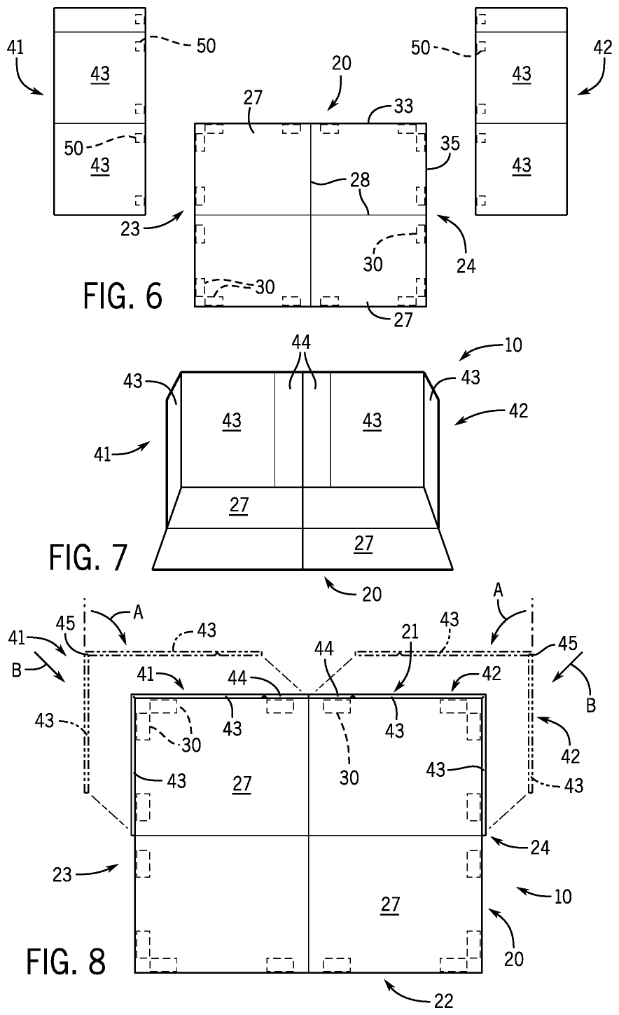

FIGS. 6-8, 9-11, 12-14, and 15-17 depict various views for erecting the workstation 10 into different erected configurations and a flat configuration, respectively. These configurations are described in greater detail herein below.

FIGS. 6-8 depict an example sequence for moving the workstation 10 into a first erected configuration (e.g., a full rear privacy configuration). Specifically, FIG. 6 depicts the base 20 and the sidewalls 41, 42 laid flat on a support surface (e.g., desk) with one sidewall 41, 42 along each side 23, 24 of the base 20. Note that the first sidewall length 46 (FIG. 2) is equal to the second base length 36 (FIG. 2). Next, the user stands the sidewalls 41, 42 up next to the base 20 and folds the sidewall 41, 42 along the seam 45 (see arrow A) into the position depicted by dashed-double-dot lines in FIG. 8. The user further moves the sidewalls 41, 42 toward the base 20 into position along the sides 23, 24 and the first end 21 (rear) of the base 20 (see solid lines and arrows B). The magnets 50 (FIG. 2) in the sidewall panels 43, 44 magnetically couple to the magnets 30 in the base panels 27. Thus, the sidewalls 41, 42 extend along the entire first end 21 (rear) of the base 20 and along a portion of the sides 23, 24. Specifically, the one of the first sidewall panels 43 and the second sidewall panel 44 extend along the end 33 of the base 20 and the other first sidewall panel 43 extend along the sides 23, 24 of the base 20. Note that ends of the first sidewall 41 and the second sidewall 42 are adjacent to each other and the ends may abut each other while the workstation 10 is in the first erected configuration. The sidewalls 41, 42 remain erect relative to the base 20 until the user applies forces to the sidewalls 41, 42 to thereby overcome the magnetic forces between the magnets 30, 50. Note that the first sidewall length 46 (FIG. 2) plus the second sidewall length 47 is equal to the second base length 36 (FIG. 2).

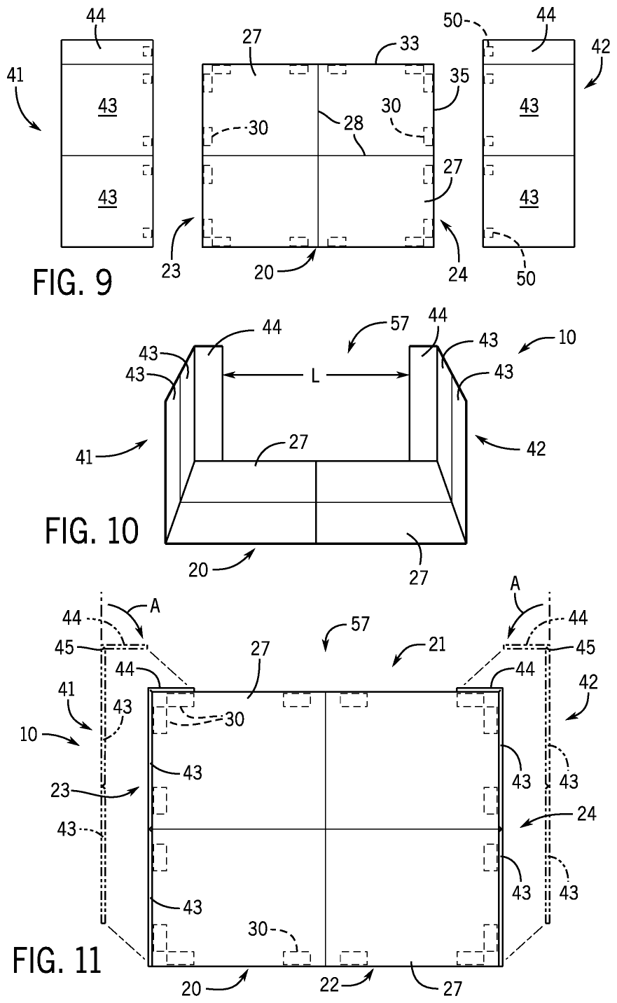

FIGS. 9-11 depict an example sequence for moving the workstation 10 into a second erected configuration (e.g., a full side privacy configuration). Specifically, FIG. 9 depicts the base 20 and the sidewall 41, 42 laid flat on a support surface (e.g., desk) with one sidewall 41, 42 along each side 23, 24 of the base 20. Next, the user stands the sidewalls 41, 42 up next to the base 20 and folds the sidewall 41, 42 along the seam 45 (see arrow A) into the position depicted by dashed-double-dot lines in FIG. 11. The user further moves the sidewalls 41, 42 toward the base 20 into position along the sides 23, 24 and the first end 21 (rear) of the base 20 (see solid lines and arrows B). The magnets 50 (FIG. 2) in the sidewall panels 43, 44 magnetically couple to the magnets 30 in the base panels 27. Thus, the sidewalls 41, 42 extend partially along the first end 21 (rear) of the base 20 and along the entire sides 23, 24 of the base 20. Specifically, the second sidewall panels 44 are along the first end 21 of the base 20 and the first sidewall panels 43 are along the sides 23, 24 of the base 20. Note that the sidewalls 41, 42 define an length L therebetween along the first end 21 of the base 20.

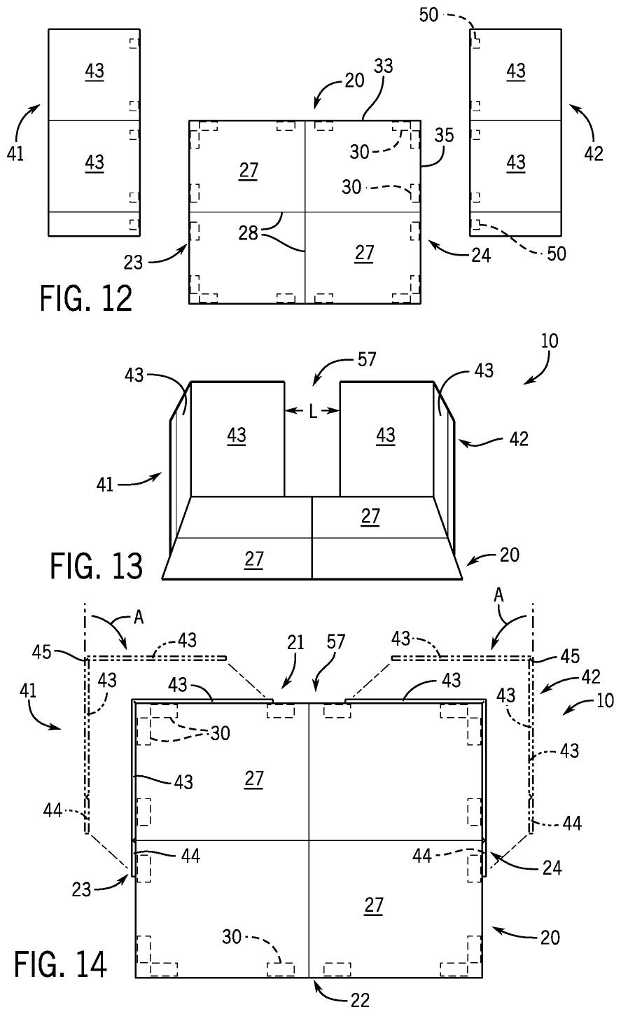

FIGS. 12-14 depict an example sequence for moving the workstation 10 into a third erected configuration (e.g., a cord opening configuration). Specifically, FIG. 12 depicts the base 20 and the sidewalls 41, 42 laid flat on a support surface (e.g., desk) with one sidewall 41, 42 along each side 23, 24 of the base 20. Next, the user stands the sidewalls 41, 42 up next to the base 20 and folds the sidewall 41, 42 along the seam 45 (see arrow A) into the position depicted by dashed-double-dot lines in FIG. 14. The user further moves the sidewalls 41, 42 toward the base 20 into position along the sides 23, 24 and the first end 21 (rear) of the base 20 (see solid lines and arrows B). The magnets 50 (FIG. 2) in the sidewall panels 43, 44 magnetically couple to the magnets 30 in the base panels 27. Thus, the sidewalls 41, 42 extend partially the entire first end 21 (rear) of the base 20 and along a portion of the sides 23, 24. Specifically, the one of the first sidewall panels 43 and the second sidewall panel 44 extend along the sides 23, 24 of the base 20 and the other first sidewall panel 43 extend along the first end 21 of the base 20. The sidewalls 41, 42 remain erect relative to the base 20 until the user applies forces to the sidewalls 41, 42 to thereby overcome the magnetic forces between the magnets 30, 50. Note that the length L of the opening 57 between the sidewalls 41, 42 while the workstation 10 is in the third erected position (FIG. 13) is less than the length L of the opening 57 when then the workstation 10 is in the second erected position (FIG. 10).

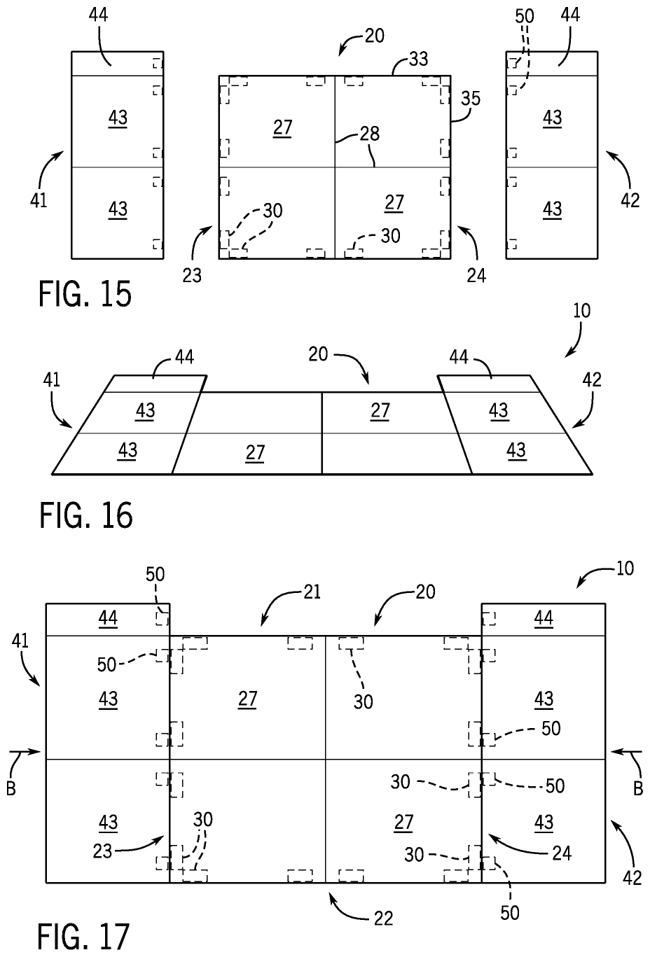

FIGS. 15-17 depict an example sequence for moving the workstation 10 into a flat configuration (e.g., expanded surface area configuration). Specifically, FIG. 15 depicts the base 20 and the sidewalls 41, 42 laid flat on a support surface (e.g., desk) with one sidewall 41, 42 along each side 23, 24 of the base 20. Next, the user moves (see arrow B) the sidewalls 41, 42 toward the base 20 into position along the sides 23, 24 (FIGS. 16-17). The magnets 50 (FIG. 2) in the sidewall panels 43, 44 magnetically couple to the magnets 30 in the base panels 27. Thus, the sidewalls 41, 42 are coupled to the sides 23, 24 of the base 20. As such, the sidewalls 41, 42 and the base 20 lie in the same plane. The sidewalls 41, 42 remain connected to the base 20 until the user applies forces to the sidewalls 41, 42 to thereby overcome the magnetic forces between the magnets 30, 50.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives and modifications are possible within the scope of the appended claims.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A portable workstation comprising:
a base having a perimeter and a plurality of base fasteners positioned along the perimeter;
a first sidewall with a side and a plurality of sidewall fasteners positioned along the side, wherein first sidewall is coupled to the base by positioning the side of the first sidewall along the perimeter such that at least one sidewall fastener of the first sidewall couples to one of the base fasteners; and
a second sidewall with a side and a plurality of sidewall fasteners positioned along the side, wherein second sidewall is coupled to the base by positioning the side of the second sidewall along the perimeter such that at least one sidewall fastener of the second sidewall couples to one of the base fasteners;
wherein the first sidewall and the second sidewall can be coupled to the base in different positions relative to the base to thereby change the configuration of the workstation.

2. The portable workstation according to claim 1, wherein the plurality of base fasteners, the plurality of sidewall fasteners of the first sidewall, and the plurality of sidewall fasteners of the second sidewall are magnets.

3. The portable workstation according to claim 2, wherein the base is rectangular and has opposing sides and opposing ends, and wherein four magnets are along each end and side of the base.

4. The portable workstation according to claim 2, wherein the base includes a plurality of base panels coupled together such that the base is foldable.

5. The portable workstation according to claim 4, wherein the base includes a seam between each base panel and wherein the base has opposing sides and opposing ends; and
wherein the magnets of the base are each spaced a first distance away from an adjacent seam, end, or side of the base.

6. The portable workstation according to claim 5, wherein the first sidewall includes a plurality of sidewall panels coupled together such that the first sidewall is foldable, and wherein the first sidewall includes opposing ends and a seam between each sidewall panel;
wherein the magnets of the first sidewall are each spaced the first distance away from an adjacent seam of the first sidewall or adjacent end of the first sidewall.

7. The portable workstation according to claim 1, wherein the base fasteners are embedded in the base and the sidewall fasteners are embedded in the first sidewall and the second sidewall.

8. The portable workstation according to claim 1, wherein the first sidewall and the second sidewall are positioned along the perimeter of the base such that the base, the first sidewall, and the second sidewall lie in a plane and the workstation is in a flat configuration.

9. The portable workstation according to claim 1, wherein the first sidewall and the second sidewall are positioned along the perimeter of the base such that the first sidewall and the second sidewall extend transverse to the base and the workstation is in an erected configuration.

10. The portable workstation according to claim 9, wherein the base has opposing sides and opposing ends;
wherein the first sidewall and the second sidewall are positioned along the perimeter of the base such that the workstation is in a first erected configuration in which:
the first sidewall extends along one side of the opposing sides;
the second sidewall extends along the other side of the opposing sides; and
the first sidewall and the second sidewall further extend along one end of the base such that an end of the first sidewall and an end of the second sidewall are adjacent to each other.

11. The portable workstation according to claim 10, wherein the adjacent end of the first sidewall and adjacent end of the second sidewall abut each other.

12. The portable workstation according to claim 10, wherein the first sidewall has a pair of first sidewall panels each with a first sidewall length and a second sidewall panel with a second length; and
wherein the base has a base panel having an end with a first base length and a side with a second base length, the first base length equals the summation of the first sidewall length and the second sidewall length and the second base length equals the first sidewall length.

13. The portable workstation according to claim 10, wherein the first sidewall and the second sidewall are positioned along the perimeter of the base such that the workstation is in a second erected configuration in which:
the first sidewall extends along one side of the opposing sides;
the second sidewall extends along the other side of the opposing sides;
the first sidewall and the second sidewall further extend along one end of the opposing ends and define an opening between an end of the first sidewall and an end of the second sidewall.

14. The portable workstation according to claim 13, wherein the first sidewall and the second sidewall are positioned along the perimeter of the base such that the workstation is in a third erected configuration in which:
the first sidewall extends along one side of the opposing sides;
the second sidewall extends along the other side of the opposing sides;
the first sidewall and the second sidewall further extend along one end of the opposing ends and define an opening between the end of the first sidewall and the end of the second sidewall;
wherein length of the opening between the first sidewall and the second sidewall when the workstation is in the third erected configuration is less than the length of the opening between the first sidewall and the second sidewall when the workstation is in the second erected configuration.

15. The portable workstation according to claim 1, wherein the base includes a plurality of base panels coupled together such that the base is foldable into and between a unfolded position in which each base panel in the plurality of panels lies in a plane and a folded position in which the base panels in the plurality of panels are stacked relative to each other.

16. The portable workstation according to claim 15, wherein the first sidewall includes a pair of first sidewall panels and a second sidewall panel, the first sidewall panels and the second sidewall panel are coupled together such that the first sidewall is foldable into a folded position in which the first sidewall panels and the second sidewall panel are stacked relative to each other.

17. The portable workstation according to claim 16, wherein the first sidewall in the folded position can be stacked on the base.

18. A method for erecting a portable workstation comprising:
positioning a plurality of base fasteners along a perimeter of a base;
positioning a plurality of sidewall fasteners along a side of a first sidewall,
positioning a plurality of sidewall fasteners along a side of a second sidewall.
moving the side of the first sidewall into a position along the perimeter of the base such that at least one sidewall fastener of the first sidewall couples to one of the base fasteners and moving the side of the second sidewall into a position along the perimeter of the base such that at least one sidewall fastener of the second sidewall couples to one of the base fastener, wherein the position of the first sidewall relative to the base and the position of the second sidewall relative to the base corresponds to a desired configuration of the workstation.

19. The method according to claim 18, wherein the desired configuration of the workstation is a erected configuration in which the first sidewall and the second sidewall extend transverse to the base.

20. The method according to claim 19, wherein the first sidewall and the second sidewall are positioned along the perimeter of the base such that an end of the first sidewall and an end of the second sidewall defines an opening along an end of the base.
